(19) United States
(12) Patent Application Publication
(10) Pub. No.: US 2011/0007096 A1
(43) Pub. Date: Jan. 13, 2011

(54) CONTENT DISPLAY METHOD, CONTENT DISPLAY PROGRAM, AND CONTENT DISPLAY DEVICE

(75) Inventor: Tsuyoshi Miyano, Chiba (JP)

Correspondence Address: MORRISON & FOERSTER LLP, 425 MARKET STREET, SAN FRANCISCO, CA, 94105-2482, US

(73) Assignee: ACCESS CO., LTD., CHIYODA-KU, TOKYO (JP)

(21) Appl. No.: 12/866,032

(22) PCT Filed: Feb. 3, 2009
(86) PCT No.: PCT/JP2009/051809

§ 371 Date: Aug. 3, 2010

(30) Foreign Application Priority Data
Feb. 4, 2008 (JP) 2008-023783

(51) Int. Cl. G09G 5/00

(52) U.S. Cl. 345/660

(57) ABSTRACT

According to the present invention, there is provided a content display method of analyzing contents created especially for a display area wider than a screen size and displaying a partial area of the content based on a result of analysis. The method includes: a step of generating, based on a result of the analysis, a first image generated by reducing an image of a predetermined range including at least the partial area of the contents which is being displayed or to be displayed on the screen; a step of calculating a height and a width of the contents; a step of generating a second image representing the height and the width of the content based on a result of the calculation and a displaying size of the first image; a step of generating, based on a position of the partial area of the contents, a guide image in which the first image is arranged on the second image and a third image representing a position and a size of the partial area is arranged on the first image; and a step of displaying the generated guide image on the screen.

### TECHNICAL FIELD

The present invention relates to a content display method, a content display program and a content display device configured to display a partial area of contents created especially for a display area wider that a screen size.

### BACKGROUND OF THE INVENTION

Information browsing software (hereafter, referred to as a “browser”) for browsing information on a network is well known and has been practically used. On the browser, a function of analyzing information on a network (e.g., a Web page which is a document described in a markup language, such as HTML (Hyper Text Markup Language) or XHTML (Extensible Hyper Text Markup Language)), and generating data for onscreen representation (hereafter, referred to as “rendering”) based on a result of the analysis is implemented. By designating an URI (Uniform Resource Identifier) of Web contents which a user wants to browse, the user is able to browse a desired Web page on the browser. Such browsers have been installed on various types of devices, such as a mobile phone, a PDA (Personal Digital Assistant), and an information home appliance, as well as a PC (Personal Computer).

Since performance and functions of a mobile phone are limited in comparison with a PC, conventionally a mobile phone was able to display only Web contents which are described in a markup language dedicated for a mobile phone (e.g., Compact-HTML, HDML (Handheld Device Markup Language), and MML (Mobile Markup Language)). However, as a result of enhancement of performance and functions of mobile phones in accordance with technological advance in recent years, a mobile phone, in which a full browser capable of displaying Web contents (hereafter, referred to as “contents for a PC”) created assuming that the Web contents are browsed by a hypothetical PC having a standard screen size, such as XGA (eXtended Graphics Array), is installed, has been practically and widely used.

Incidentally, the mobile phone is required to have portability, the size of a display mounted on the mobile phone is limited. For this reason, the display of the mobile phone has a screen size, such as QVGA (Quarter Video Graphics Array), smaller than that of a display for a PC. Therefore, when contents for a PC are displayed by the browser of the mobile phone in the same scaling as that used in displaying of contents by a browser of a PC, only information in a limited area of the contents is displayed by the browser of the mobile phone with respect to information displayed by the browser of the PC. If the amount of information displayed on a screen is small as described above, it becomes difficult for the user of the mobile phone to get an overview of the contents for a PC.

In this point of view, various types of technologies for enhancing usability for displaying a wider area of contents through a limited screen size have been proposed. As an example of such a technology, Japanese Patent Provisional Publication No. SHO 61-241866 (hereafter, referred to as patent document #1) discloses a document creation apparatus which displays, in one screen, an input area (an enlarged image) to which letters can be inputted and a layout area (a reduced image) in which a layout of an entire document (a unit of document, such as one page) is displayed. By using the apparatus disclosed in patent document #1, the user is able to get an overview of the entire document being edited by visually identifying the reduced image of the entire document (or a unit of document such as one page), while editing the document by inputting letters into the enlarged image of a part of the document.

European Published Patent Application No. 1255186 (hereafter, referred to as patent document #1) discloses a browser for a mobile phone which is capable of displaying Web contents by switching between displaying of the entire Web contents and displaying of a part of the Web contents. The browser described in patent document #2 reduces the entire Web contents to display the entire Web contents in one screen, and is able to display, in inverse video, an area of the Web contents that can be displayed on a display when the Web contents are enlarged to the extent that legibility is secured. When the user operates a predetermined operation key while such a screen is displayed, the area in inverse video on the Web contents is displayed within the entire screen of the mobile phone. By using the browser for a mobile phone described in patent document #2, the user is able to recognize the position of an actual browsing area with respect to the entire Web contents by appropriately switching onscreen representation.

### DISCLOSURE OF THE INVENTION

The document creation apparatus described in patent document #2 executes a pre-process in which the entire document stored in an inner buffer is processed to generate drawing data and to write the drawing data into a layout memory buffer, and thereafter displays, on a screen, the drawing data in the layout memory buffer as a reduced image of the entire document. The pre-process requires a processing time which is in proportion to the size of the document data. Therefore, if a data amount of Web contents is large to such an extent that a scrolling operation is required even when the Web contents are displayed on a display for a PC, the pre-processing requires a considerable length of time. Therefore, a problem arises that a reduced image of the entire document can not be displayed quickly. In addition, for a mobile phone which is a device of a type whose resources are limited, processing of the pre-process for Web contents having a large data amount is unfavorable. Furthermore, it becomes necessary to reduce the Web contents more greatly as the size (i.e., the height and width) of the Web contents becomes larger. However, as the reducing ratio becomes greater, the extent to which text and images in the Web content are crushed becomes greater. There is a possibility that the degree of visibility of a reduced image might decrease considerably and the user becomes unable to easily recognize an aspect of the Web contents. In addition, when a unit (e.g., one page) of the document is processed, another problem arises that it becomes difficult for the user to recognize the position of the document corresponding to the reduced image in the entire document.

For the browser for a mobile phone described in patent document #2, the user is not able to browse simultaneously both of a reduced image of the entire Web contents and an enlarged image of a part of the Web contents. Therefore, the user is required to switch the onscreen representation if the user wants to get an overview of the Web contents in a state where the user is browsing a part of the Web contents in an enlarged view. That is, the user is required to conduct a complicated operation. In addition, it is estimated that, since the onscreen representation is switched, it becomes difficult for the user to recognize a positional relationship between the area in an enlarged view and the entire Web contents. Furthermore, as in the case of patent document #1, there are concerns that, in proportion to a data amount of the Web contents, the processing time and the processing load for displaying the entire Web contents increase, and the degree of visibility of the reduced image decreases considerably.

In consideration of the above described circumstances, the object of the present invention is to provide a content display method, a content display program and a content display device suitable for enabling a user to easily get an overview of Web contents in Web browsing on a terminal device having a small amount of resources.

According to an embodiment of the present invention, there is provided a content display method of analyzing contents created especially for a display area wider than a screen size and displaying a partial area of the contents based on a result of analysis. The method includes: a first image generation step of generating, based on a result of the analysis, a first image generated by reducing an image of a predetermined range including at least the partial area of the contents which is being displayed or to be displayed on the screen; a step of calculating a height and a width of the contents; a second image generation step of generating a second image representing the height and the width of the contents based on a result of the calculation and a displaying size of the first image; a guide image generation step of generating, based on a position of the partial area of the contents, a guide image in which the first image is arranged on the second image and a third image representing a position and a size of the partial area is arranged on the first image; and a guide image displaying step of displaying the generated guide image on the screen.

By executing the above described content display method, it becomes possible to enable a user to grasp the position of the current browsing area in the entire content and to get an overview of the content. Furthermore, since a target area of the reduced image is limited to an limited area, not the entire content, time for generating the reduced image and required resources do not depend on the data amount of the content. Furthermore, the reducing factor of the first image does not depend on the size (the height and width) of the content, inconvenience that the visibility of the first image which is the reduced image deteriorates considerably does not occur.

The content display method may further comprise: a screen scroll step of executing scrolling for the contents in accordance with an input operation by a user; and an image moving step of moving the third image in the first image in response to an operating amount of the scrolling or moving the first image in the second image while moving the third image in the first image in response to the operating amount of the scrolling, and wherein, when the first image is moved in the image moving step, the first image may be updated by an image including an image of the partial area to which the content has been scrolled.

In the above described content display method, the guide image may be displayed on the screen only while the scrolling is executed.

Preferably, in the second image generation step, a height and a width of the second image are calculated based a result of the calculation and a displaying size of the first image, and when the calculated height and the width of the second image exceed a predetermined height and a predetermined width, the calculated height and width are reduced to the predetermined height and the predetermined width.

According to an embodiment of the invention, there is provided a content display program for causing a computer to execute the above described content display method.

By using the above described content display program, it becomes possible to enable a user to grasp the position of the current browsing area in the entire content and to get an overview of the content. Furthermore, since a target area of the reduced image is limited to an limited area, not the entire content, time for generating the reduced image and required resources do not depend on the data amount of the content. Furthermore, the reducing factor of the first image does not depend on the size of the content, inconvenience that the visibility of the first image which is the reduced image deteriorates considerably does not occur.

According to an embodiment of the invention, there is provided a content display device which is able to display a partial area of contents created especially for a display area wider than a screen size. The content display device includes: a content analyzing means which analyzes the contents; a first image generation means which generates, based on a result of the analysis, a first image generated by reducing an image of a predetermined range including at least the partial area of the contents which is being displayed or to be displayed on the screen; a calculating means which calculates a height and a width of the contents; a second image generation means which generates a second image representing the height and the width of the contents based on a result of the calculation and a displaying size of the first image; and a guide image generation means which generates, based on a position of the partial area of the contents, a guide image in which the first image is arranged on the second image and a third image representing a position and a size of the partial area is arranged on the first image, and wherein the generated guide image is displayed on the screen.

According to the thus configured content display device, it becomes possible to enable a user to grasp the position of the current browsing area in the entire content and to get an overview of the content. Furthermore, since a target area of the reduced image is limited to an limited area, not the entire content, time for generating the reduced image and required resources do not depend on the data amount of the content. Furthermore, the reducing factor of the first image does not depend on the size (the height and width) of the content, inconvenience that the visibility of the first image which is the reduced image deteriorates considerably does not occur.

The content display device may further include: a screen scroll means which executes scrolling for the contents in accordance with an input operation by a user; and an image moving means which moves the third image in the first image in response to an operating amount of the scrolling or moving the first image in the second image while moving the third image in the first image in response to the operating amount of the scrolling, and wherein, when the first image is moved by the image moving means, the first image is updated by an image including an image of the partial area to which the content has been scrolled.

The content display device may be configured such that the guide image is displayed on the screen only while the scrolling is executed.

Preferably, the image generation means has the function of calculating a height and a width of the second image based a result of the calculation and a displaying size of the first image, and reducing the calculated height and width to a predetermined height and a predetermined width, when the calculated height and the width of the second image exceed the predetermined height and the predetermined width.

According to an embodiment of the invention, there is provided a content display program which analyzes contents created especially for a display area wider than a screen size and displays a partial area of the contents. The content display program causing a computer to function as: a first image generation means which generates, based on a result of the analysis, a first image generated by reducing an image of a predetermined range including at least the partial area of the contents which is being displayed or to be displayed on the screen; a second image generation means which generates a second image representing an entire area of the contents based on a result of the analysis and a displaying size of the first image; a guide image generation means which generates, based on a position of the partial area of the contents, a guide image in which the first image is arranged on the second image and a third image representing a position and a size of the partial area is arranged on the first image; and a guide image display means which displays the generated guide image at a position not obstructing browsing of the contents on the screen.

As described above, according to the embodiment which will be explained in detail below, it becomes possible to provided the content display method, the content display program and the content display device suitable for enabling the user to easily recognize an overview of the Web content in Web browsing on a terminal device having a smaller amount of resources, and the position of the actually displayed area in the entire Web content.

### BRIEF DESCRIPTION OF THE DRAWINGS

FIG. 1 illustrates a general outer appearance of a terminal device according to an embodiment of the invention.

FIG. 2 is a block diagram illustrating a general configuration of the terminal device according to the embodiment of the invention.

FIG. 3 is a general functional block diagram of a browser engine included in a browser according to the embodiment of the invention.

FIG. 4 is a display example of content for a PC displayed on the browser according to the embodiment of the invention.

FIG. 5 is a display example of content for a PC displayed on the browser according to the embodiment of the invention.

FIG. 6 is a flowchart of a bar generation process executed by the browser according to the embodiment of the invention.

FIG. 7 is a flowchart illustrating a bar scroll process executed by the browser according to the embodiment of the invention.

### BEST MODE FOR CARRYING OUT THE INVENTION

First, terms used herein are defined as follows.

Network: Various types of networks including a mobile communication network of a mobile communication carrier, an intranet and the Internet.

Contents: a group of information including video, an image, sound, a document, data such as a work sheet or a combination thereof to be browsed by a user. Contents are transmitted through a network or is stored in a terminal device.

Web contents: a form of contents. The Web contents are a group of information created or browsed by utilizing Web technology.

Web page: a form of Web contents. The Web page represents an entire content to be displayed when a user designates an URL. That is, the Web page represents an entire content which can be displayed by scrolling onscreen representation on a display. The Web page includes not only a Web page being browsed online but also a Web page being browsed offline. The Web page being browsed offline includes, for example, a page which is cached by a browser after having been received from the Internet, or a page stored, for example, in a local folder of a terminal device in an mht format. The Web page includes various types of information (Web page data), such as, an HTML document, an XHTML document, an image file, sound data and etc.

According to the above described definitions, contents include Web contents, and Web contents include a Web page.

Hereafter, an embodiment of the invention is explained with reference to the accompanying drawings.

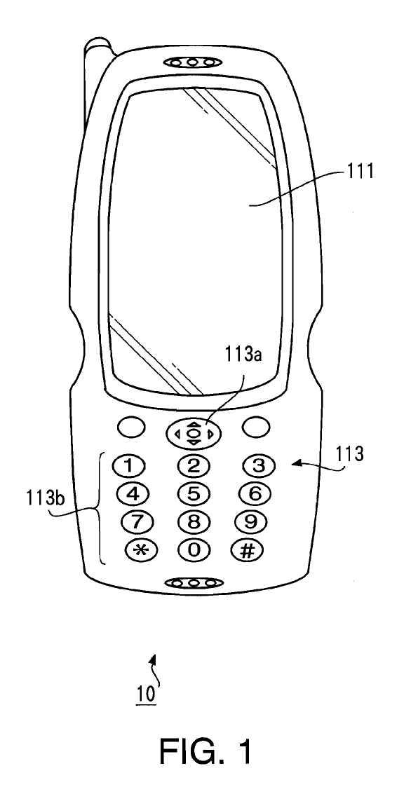

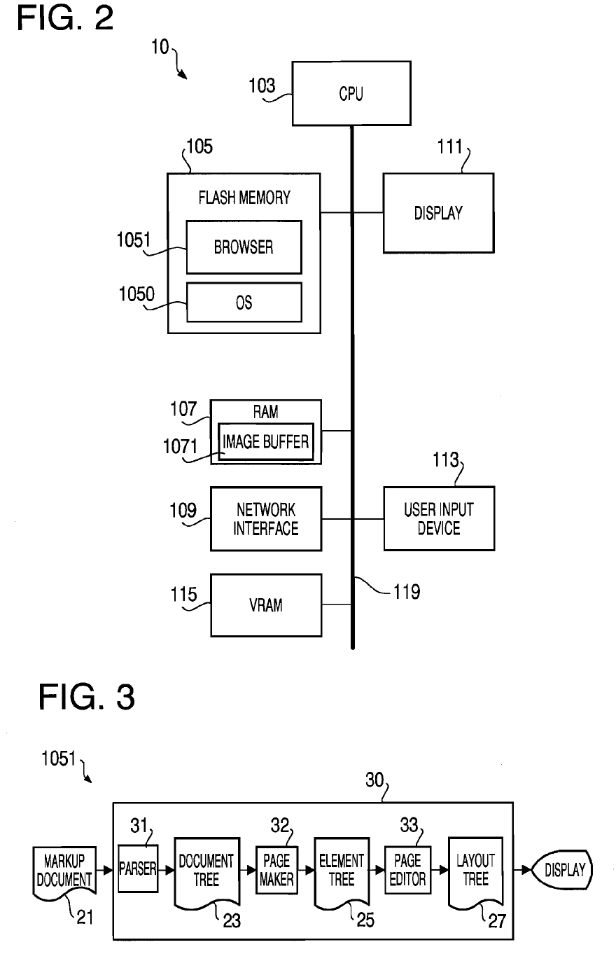

FIG. 1 illustrates a general outer appearance of a terminal device 10 according to the embodiment of the invention. FIG. 2 is a block diagram illustrating a general configuration of the terminal device 10. Although the terminal device 10 according to the embodiment is configured as a mobile phone, the present invention may also be implemented on various types of terminals, such as, a PDA, a PHS (Personal Handy Phone System), a portable game machine, a home appliance and etc., on which a browser has been installed. The present invention can be effectively implemented especially on various types of devices whose display has the number of pixels smaller than that of a display for a PC.

As shown in FIG. 2, the terminal device 10 includes a CPU (Central Processing Unit) 103 which totally controls the device. To the CPU 103, various components of the terminal device 10 are connected via a bus 119. The CPU 103 achieves various functions by communicating with other components via the bus 119. The components include a flash memory 105, a RAM (Random Access Memory) 107, a network interface 109, a display 111, a user input device 113 and a VRAM (Vide Random Access Memory) 115. The bus 119 includes a power line as well as data lines. Power is supplied to the various components in the terminal device 10, such as the CPU 10, from a battery (not shown) via the bus 119.

The flash memory 105 stores an OS (Operating System) 1050 which manages totally the terminal device 10 and various applications including a browser 1051 running on the OS 1050. The browser 1051 is information browsing software for browsing contents described in a markup language online or offline. The browser 1051 supports Web contents for mobile devices described, for example, in compact HTML, in addition to supporting Web contents for PCs.

The RAM 107 is a main memory of the terminal device 10, i.e., the RAM 107 is a loading destination into which various types of data to be used by the CPU 103 and programs are loaded. For example, when an operation for invoking the browser 1051 is conducted through the user input device 113, the browser 1051 is read from the flash memory 105 and is loaded into a work area in the RAM 107. The browser 1051 and hardware such as the CPU 103 execute processes in cooperation with each other, so that a user is able to enjoy Web browsing, i.e., to browse Web contents, through the display 111.

As the user input device 113, the terminal device 10 is provided with a 5-way key 113a (a combination key including four direction keys (upward, downward, left and right direction keys) and an Enter-key), and a ten-key 113b. When a key operation is conducted by the user through the user input device 113, a signal corresponding to the key operation is input to the CPU 103. By executing a process corresponding to the input signal through the CPU 103, various types of functions, such as Web browsing, can be achieved on the terminal device 10. By operating the 5-way key 113a and the ten-key 113b, the user is able to scroll the Web contents being browsed on a screen.

It should be noted that the user input device 113 is not limited to a mechanical key, such as the 5-way key 113a and the ten-key 113b. The user input device 113 may be configured by another type of key input device, such as a membrane key or a touch panel.

If the user input device 113 is configured by a touch panel, an operation screen corresponding to operation keys is configured by a display screen which is integrated with the display 111 or is provided separately from the display 111. In the former case, the display 111 itself is configured with a touch panel. In the latter case, the terminal device 10 includes two screens, i.e., the display 111 and an operation touch panel. Furthermore, in the latter case, whether to configure the display 111 with a touch panel is determined in accordance with design specifications.

As described above, if the user input device 113 is configured with a touch panel, a GUI (Graphical User Interface) environment in which operation such as scrolling is conducted by pen touching or finger touching on an operation key displayed on the screen is provided. It is also possible to provide a GUI environment where various operations are conducted, for example, by directly touching on Web contents. Under such a GUI environment, when the user moves the user's finger on a touch panel surface in the upward, downward, left or right direction from a state where the user's finger touches the touch panel surface at a certain point on the Web contents, scrolling is executed accordingly (e.g., by moving the user's finger on the touch panel surface from the bottom to top, the Web contents are scrolled downward). That is, in this case, scrolling is executed in response to movement of a stylus or a finger, more intuitive operability can be provided to the user.

The user input device 113 may be configured by appropriately combining various types of keys, such as a mechanical key, a membrane key and a touch panel. Furthermore, the user input device 113 may be an operation terminal (e.g., a remote controller) provided separately from the terminal device 10.

Furthermore, a component other than a mechanical key, a membrane key and a touch panel may be installed in the user input device 113. As examples of such a component, a gyro-sensor, an acceleration sensor and a jerk sensor are named. In this case, the CPU 103 measures, for example, a tilting angle, an angular velocity, an acceleration, and a jerk (a time-rate-of-change of an acceleration), so that scrolling responsive to measured values can be achieved by cooperation between the CPU 103 and the browser 1051. For example, when the user moves or tilts the terminal device 10 in upward, downward, left or right direction, scrolling responsive to the moving direction, moving speed or the tilting angle, etc. is executed. Such a configuration enables the user to intuitively scroll a display area of the Web contents.

The terminal device 10 according to the embodiment is designed to have a screen aspect ratio of 3:4 (i.e., portrait representation) in a normal use state (i.e., in a state where the terminal device 10 is oriented such that the up-and-down direction in FIG. 1 coincides with the vertical direction). When the posture of the terminal device 10 varies from the above described state, the CPU 103 detects change of the posture of the terminal device 10 based on outputs from the sensors such as the gyro sensor. For the Web contents being displayed on the display 111, the browser 1051 executes rendering responsive to the posture of the terminal device 10 based on detection results by the CPU 103. For example, when the terminal device 10 is rotated by 90 degrees from the posture shown in FIG. 1, the screen aspect ratio changes to 4:3 (i.e., landscape representation). At this time, the browser 1051 executes again rendering for the Web contents being displayed on the display 111 in accordance with the landscape screen. As described above, if the orientation of the screen is changed, line-wrapping of text during the rendering are also changed, and, as a result, appearance of the Web page changes.

As shown in FIG. 1, the terminal device 10 according to the embodiment is configured as a so-called straight type mobile phone which holds the display 11 and the user input device 113 with an integrated body. However, the terminal device 10 may employ another body type. In another embodiment, a folding type, a rotational biaxial hinge type, a cycloid type or a swing type structure may be employed. For example, a mobile phone of a cycloid type or a swing type is configured such that a display side body holding a display is rotatable relative to a main body in a plane parallel with the display 111. In such a mobile phone, the orientation of the screen changes in response to the rotational angle of the display side body. The browser 1051 executes again rendering for the Web contents being displayed on the display 111 so as to accord with the changed orientation of the screen.

Next, functions of the browser 1051, specially a browser engine 30 which is a primary component of the browser 1051, are explained in detail. FIG. 3 illustrates a functional block diagram of the browser engine 30. As shown in FIG. 3, the browser engine 30 includes various functional blocks including a parser 31, a page maker 32 and a page editor 33.

When accessing operation to Web contents (e.g., input of a URI through the user input device 113) is conducted (or a URI is designated by selection of an anchor element on the Web contents or a URI stored as a bookmark or history in the terminal device 10 is selected), the browser 1051 generates a request message requesting for resources such as Web contents in compliance with HTTP (Hypertext Transfer Protocol), and transmits the request message to a designated URI.

Then, a server corresponding to the designated URI generates a response message corresponding to the received request message and replies. The replied response message reaches to the browser 1051 through the network and the response message is passed to the parser 31. In a message body of the response message, a markup document 21, to which a URI is designated, which is described in HTML or XHTML, etc., is embedded. It should be noted that the markup document 21 describes contents for a PC which has been created especially for the screen size of a display for a PC (which is larger than the screen size of the display 111 of the terminal device 10).

The parser 31 analyzes the markup document 21, generates a document tree 23 which represents a logical structure (i.e., elements configuring the markup document 21 and a cross relationship between the elements) of the markup document 21 in a tree structure (for example, a DOM (Document Object model) tree), and loads the document tree into the RAM 107. Further, the document tree 23 is data which has nodes corresponding to respective elements of the markup document 21 and which represents an outline of the markup document 21. The document tree 23 only describes the logical structure of the markup document 21, and does not include information about representation of the document.

The page maker 32 generates an element tree 25 including information of a display style, such as block, inline, table, and list, etc., based on the document tree 23, and executes a registration of a request of an image and an event process designated in the markup document 21 to be stored in the RAM 107. The element tree 25 represents an order in which block, inline, and table, etc., exist. However, the element tree 25 does not include information about which position and with what widths and heights these elements (block, inline, table, etc.) are displayed, and information about from where the text is wrapped, etc.

Incidentally, the browser 1051 has the function of rendering Web contents in various types of scaling factors and display modes. The following explanation is give on the assumption that the browser 1051 has been set to a mode where contents for a PC are rendered so as to be browsed in the same layout (hereafter, referred to as a “standard layout”) as that for the contents for a PC being browsed on a display for a PC having a standard screen size. For convenience of explanation, a display area of a hypothetical display of a PC having a standard screen size is referred to as a “hypothetical display area”.

Accordingly, a page editor 33 determines one-by-one the layout (i.e., wrapping of text, and a position, width and height of each element on the screen) and a color of each node (element) of the element tree 25, and generates a layout tree 27 representing a layout of each element. Furthermore, each time a layout is determined for each element, the page editor 33 determines a minimum area in which elements whose layouts have been determined can be put, as a size (i.e., a vertical length (height) and a horizontal length (width) of the contents for a PC) of the entire contents for a PC, and stores a calculation result. Therefore, the page editor 33 recognizes an actual size of the entire contents for a PC after layouts for all the elements have been determined.

Each element whose layout has been determined is sequentially subjected to rendering by the page editor 33, and is recorded in an image buffer 1071 on the RAM 107. The image buffer 1071 is prepared in a predetermined area of the RAM 107, and an image area of the image buffer 1071 corresponds to the hypothetical display area, i.e., a standard screen size for a PC.

In the image buffer 1071 (i.e., the hypothetical display area), elements included in an area of the contents for a PC to be displayed on the display 111 and its surrounding area are rendered. Not all a rendering result of the entire area of the image buffer 1071 (drawing objects) is displayed on the display 111. On the display 111, a rendering result of an area (hereafter, referred to as a “designated area”) which corresponds to the screen size of the display 111 in the image buffer 1071 and which is designated by the browser 1051 is displayed.

The VRAM 115 is a memory for storing data to be directly displayed on the display 111, and has an image area corresponding to the screen size of the display 111. In the VRAM 115, data which has been rendered in the designated area in the image buffer 1071 is written. Therefore, each time an element whose layout has been determined is rendered in the image buffer 1071, a rendering result is written to the VRAM 115. Consequently, each element of the contents for a PC is displayed sequentially on the display 111. Through the above described process by the browser 1051, the contents for a PC rendered in a standard layout are displayed on the display 111.

The browser 1051 manages the position of the hypothetical display area in the entire contents for a PC, and the position of the designated area on the hypothetical display area. The browser 1051 moves the designated area in the image buffer 1071 in response to a scrolling operation conducted through the user input device 113. Since data to be written into the VRAM 115 is updated in response to movement of the designated area, an area of the contents for a PC corresponding to the scrolling operation is displayed on the display 111.

When an operating amount of scrolling exceeds a predetermined operating amount, the browser 1051 renders elements included in the display area (hypothetical display area) of the contents for a PC that has moved in response to the scrolling operation, and records the rendered elements in the image buffer 1071. That is, data of the image buffer 1071 is updated with the rendered elements included in the hypothetical display area which has moved in response to the scrolling operation in the contents for a PC.

The browser 1051 writes image data into the VRAM 115 such that an image such as an operation button is arranged at a predetermined position on the display screen. Therefore, on the display 111, the image in which the operation button and etc. are superimposed on the contents for a PC rendered in the standard layout is displayed.

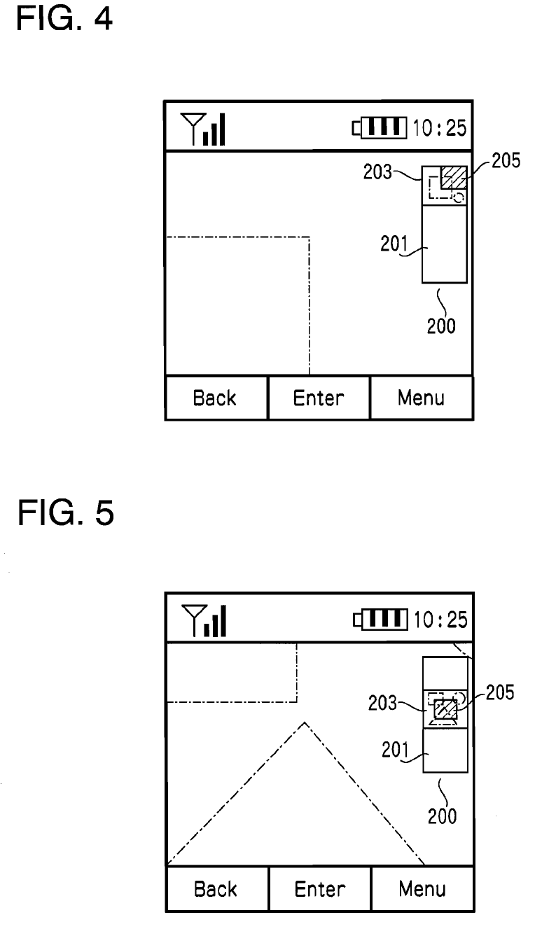

FIGS. 4 and 5 illustrate examples of contents for a PC rendered in the standard layout. In this embodiment, when scrolling is conducted during displaying of the contents for a PC, a bar 200 (an guide image) is displayed at the right edge of the display screen as shown in FIGS. 4 and 5 only during a scrolling operation (including a constant time immediately after the scrolling operation). It should be noted that in FIGS. 4 and 5 each element in the contents for a PC is indicated by a chain line.

The bar 200 includes a whole content bar 201, a hypothetical display area image 203 and a hatching part 205. The whole content bar 201 is a rectangular bar displayed in a semitransparent state, and represents the size of the whole contents for a PC (i.e., the height and width of the whole contents for a PC). The hypothetical display area image 203 is arranged on the whole content bar 201. The hypothetical display area image 203 represents an area including an area of the contents for a PC currently displayed on the display 111 and its surrounding area, and is a reduced image of the image of the hypothetical display area, i.e., a displaying range to be displayed on a display for a PC having a standard screen size. The hatching part 205 is an image displayed on the hypothetical display area image 203 in a semitransparent state, and represents an area of the contents for a PC currently displayed on the display 111.

When scrolling is conducted in leftward and downward directions in a state of FIG. 4, the hypothetical display area image 203 and the hatching part 205 move so that the bar 200 changes as shown in FIG. 5. In FIG. 5, the hypothetical display area image 203 has moved downward in an amount corresponding to a scrolling amount with respect to the whole content bar 201, and the hatching part 205 has moved leftward in an amount corresponding to a scrolling amount with respect to the hypothetical display area image 203. That is, the hypothetical display area image 203 and the hatching part 205 move in the whole content bar 200 in conjunction with scrolling operations.

Therefore, the user is able to easily recognize a current browsing position in the entire contents for a PC by visually identifying the bar 200 (specifically, by checking the position and size of the hypothetical display area image 203 or the hatching part 205 in the whole content bar 201). Furthermore, by visually identifying the hypothetical display area image 203 and the hatching part 205, the user is able to get a grasp, in a sensuous manner, on which type of content is arranged around the area currently being browsed. As a result, the user becomes able to easily image the entire contents for a PC, and thereby is able to scroll the screen quickly to a portion which the user wants to browse in the contents for a PC.

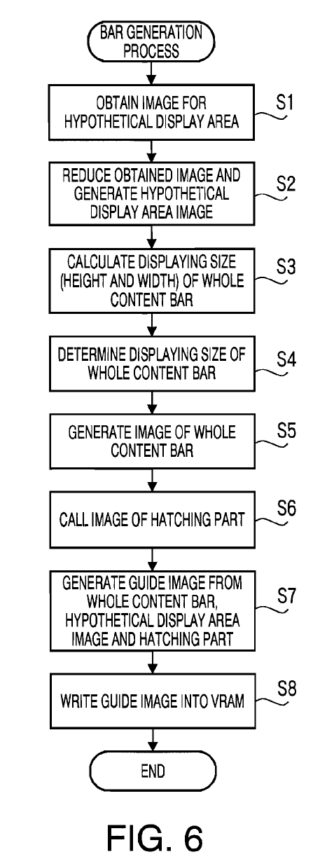

When the scrolling operation is accepted, the browser 1051 executes a bar generation process for generating the bar 200. In the following, the bar generation process is explained with reference to a flowchart shown in FIG. 6. It should be noted that in the following explanation and flowcharts, each step is abbreviated as “S”.

First, the bar generation process is explained based on the premise that the above described series of processes by the browser engine 30 from an analyzing process of the contents for a PC to a rendering process for the image buffer 107 have been finished. As shown in FIG. 6, the browser 1051 obtains an image of the entire area of the image buffer 1071 (i.e., the hypothetical display area) (S1), and reduces the obtained image to a predetermined screen size and generates the hypothetical display area image 203 (S2). Although the displaying size of the hypothetical display area image 203 is predetermined, the user is allowed to freely set the displaying size in consideration of usability.

The browser 1051 calculates the displaying size (height and width) of the whole content bar 201 based on information of the displaying size of the hypothetical display area image 203 and information of the entire contents for a PC calculated by the page editor 33 using the information of the displaying size of the hypothetical display area image 203 (S3). For example, when the contents for a PC have a height equal to four screens of a display for a PC, the height of the whole content bar 201 obtained as a result of the calculation becomes a four-hold value of the height of the hypothetical display area image 203.

In this case, there are concerns that, if the displaying size for the whole content bar 201 becomes too large, the entire contents for a PC hide behind the whole content bar 201, and therefore a browsing property for the entire contents for a PC deteriorates. For this reason, according to the embodiment, the maximum displaying height and the maximum displaying width of the whole content bar 201 have been determined in advance.

The browser 1051 compares the displaying size of the whole content bar 201 obtained in the calculation step of S3 with the maximum displaying height and the maximum displaying width of the whole content bar 201, and determines the size of the whole content bar 201 to be displayed on the display 111 (S4). For example, if the height (or the width) of the whole content bar 201 calculated in step S3 exceeds the maximum displaying height (or the maximum displaying width), the browser 1051 changes the height (or the width) of the whole content bar 201 to the maximum displaying height (or the maximum displaying width), and sets the changed size as the displaying size of the whole content bar 201. It should be noted that the maximum displaying height and the maximum displaying width can also be set freely as in the case of the displaying size of the hypothetical display area image 203.

The browser 1051 generates an image of the whole content bar 201 based on the displaying size of the whole content bar 201 determined in step of S4 (S5). Further, the browser 1051 calls an image of the hatching part 205 stored in a predetermined memory area (e.g., an area on the flash memory 105). Then, the browser 1051 generates the bar 200 (guide image) by combining the image of the whole content bar 201 generated in step of S5, the hypothetical display area image 203 generated in step of S2 and the image of the hatching part 205 called in step S6 (S7). In step S7, the browser 1051 arranges the hypothetical display area image 203 on the whole content bar 201 by considering the position of the hypothetical display area (or the designated area) in the entire contents for a PC, and further arranges the hatching part 205 on the hypothetical display area image 203 by considering the designated position on the hypothetical display area. After the image thus generated has been written into the VRAM 115, the bar 200 is displayed at the right edge on the screen as shown in FIGS. 4 and 5.

By visually identifying the bar 200 generated in the above described bar generation process, the user is able to easily recognize the position of the current browsing area in the entire contents for a PC. Furthermore, since the user is able to visually identify which type of content is arranged in the surrounding area of the current browsing area, the user is also able to get an overview of the contents for a PC. Furthermore, since the image to be rendered is limited to a certain area (hypothetical display area), not the entire contents for a PC, the advantage that time and resources required for the generation process of the bar 200 do not depend on the data amount of the contents for a PC. That is, even if the data amount of the contents for a PC is large, problems discussed in the patent documents #1 and #2 about the processing time and the processing load do not occur. Furthermore, since the reducing factor of the hypothetical display area image 203 is constant regardless of the size (height and width) of the contents for a PC, inconvenience that visibility of the reduced image considerably deteriorates does not occur.

Since the bar 200 also serves as a scroll bar that a general browser has, in the browser 1051 a scroll bar is not displayed. Therefore, the display area of the contents for a PC expands to a portion (i.e., a part of a periphery of the screen, such as a right edge and a bottom edge of the screen) where a scroll bar would be displayed conventionally, and therefore the visibility of the contents for a PC is enhanced. When the scroll operation is stopped, the bar 200 is cleared from the display 111. This point also becomes a factor for enhancing the browsing property for the contents for a PC.

Basically, each element of the contents for a PC is laid out in the direction from left to right and in the direction from top to bottom. Therefore, each element tends to be laid out leftward, and therefore there is a case where the elements do not laid out up to the right edge of the screen. Therefore, even if the bar 200 is displayed at the right edge of the screen according to the embodiment, browsing of the contents for a PC is not obstructed so much.

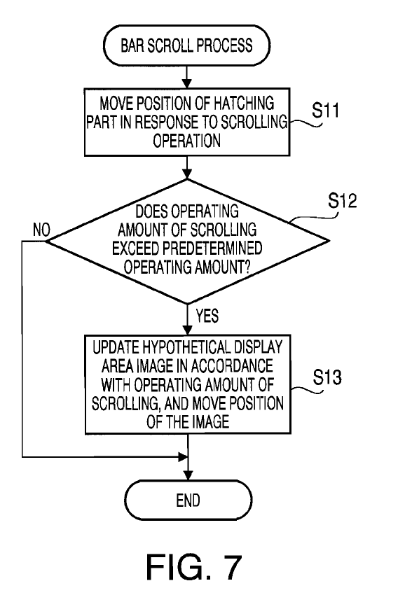

FIG. 7 is a flowchart illustrating a bar scroll process executed in accordance with the operating amount of scrolling after execution of the bar generation process shown in FIG. 6. As described above, when scrolling is conducted, the browser 1051 moves the designated area in the image buffer 1071 in response to the operating amount of scrolling. With this process, the area of the contents for a PC displayed on the display 111 is also moved. At this time, the browser 1051 moves the position of the hatching part 205 on the hypothetical display area image 203 in conjunction with the movement of the designated area (S11).

When the operating amount of scrolling exceeds a predetermined operating amount (S12: YES), the browser 1051 executes rendering to write, into the image buffer 1071, each element of the contents for a PC included in the hypothetical display area which has been moved in the contents for a PC in response to the operating amount. Then, the browser 1051 reduces the image newly rendered in the image buffer 1071, generates the hypothetical display area image 203 and arranges the hypothetical display area image 203 on the whole content bar 201, and then the browser 1051 moves the arranged hypothetical display area image 203 in the whole content bar 201 in response to the scrolling operation (S13). By thus executing the bar scroll process, onscreen representation of the bar 200 changes from FIG. 4 to FIG. 5.

Hereafter, an embodiment where the bar 200 is constantly displayed during activation of the browser 1051 is explained. A bar generation process similar to that shown in FIG. 6 is also executed in this embodiment. However, at a stage immediately after reception of a response message from the server, the analyzing process of the parser 31 and etc. are not executed. Therefore, no data has been written to the image buffer 1071 at this stage. Furthermore, at this stage, the size (height and width) of the contents for a PC is unknown for the browser 1051. Therefore, initially, a white hypothetical display area image 203 having a shape and size equal to the hypothetical display area image 203 shown in FIG. 4 or 5 is generated. Furthermore, the whole content bar 201 configured to expediently coincide with the size and width of the hypothetical display area image 203 is generated. As a result, on the display 111, the bar 200 in which the white hypothetical display area image 203 is arranged on the whole content bar 201 is displayed.

As the analyzing process by the browser engine 30 and etc. proceeds and the elements are rendered, the rendering results are successively reflected in the hypothetical display area image 203. Furthermore, each time the page editor 33 calculates the size of the contents for a PC, the whole content bar 201 is replaced with that determined based on the calculation result (i.e., the whole content bar 201 displayed on the display 111 expands to the height and width directions along with progress of the process by the browser engine 30).

The present invention is not limited to the above described embodiments, and can be varied in various ways within the scope of the technical concept of the invention. For example, the area represented by the hypothetical display area image 203 is not limited to the display area of a standard display for a PC, and can be an area selected in various ways depending on design. Furthermore, the hypothetical display area may be settable freely, for example, through a menu operation of the browser 1051. Alternatively, the hypothetical display area may change in conjunction with the posture (portrait orientation or landscape orientation) of the display 111.

1. A content display method of analyzing contents created especially for a display area wider than a screen size and displaying a partial area of the contents based on a result of analysis, comprising:
a first image generation step of generating, based on a result of the analysis, a first image generated by reducing an image of a predetermined range including at least the partial area of the contents which is being displayed or to be displayed on the screen;
a step of calculating a height and a width of the contents;
a second image generation step of generating a second image representing the height and the width of the contents based on a result of the calculation and a displaying size of the first image;
a guide image generation step of generating, based on a position of the partial area of the contents, a guide image in which the first image is arranged on the second image and a third image representing a position and a size of the partial area is arranged on the first image; and
a guide image displaying step of displaying the generated guide image on the screen.

2. The content display method according to claim 1, further comprising:
a screen scroll step of executing scrolling for the contents in accordance with an input operation by a user; and
an image moving step of moving the third image in the first image in response to an operating amount of the scrolling or moving the first image in the second image while moving the third image in the first image in response to the operating amount of the scrolling;
wherein, when the first image is moved in the image moving step, the first image is updated by an image including an image of the partial area to which the contents has been scrolled.

3. The content display method according to claim 1, wherein the guide image is displayed on the screen only while the scrolling is executed.

4. The content display method according to claim 1,
wherein, in the second image generation step, a height and a width of the second image is calculated based a result of the calculation and a displaying size of the first image, and when the calculated height and the width of the second image exceed a predetermined height and a predetermined width, the calculated height and width are reduced to the predetermined height and the predetermined width.

5. (canceled)

6. A content display device which is able to display a partial area of contents created especially for a display area wider than a screen size, comprising:
a content analyzing unit which analyzes the contents;
a first image generation unit which generates, based on a result of the analysis, a first image generated by reducing an image of a predetermined range including at least the partial area of the contents which is being displayed or to be displayed on the screen;
a calculating unit which calculates a height and a width of the contents;
a second image generation unit which generates a second image representing the height and the width of the contents based on a result of the calculation and a displaying size of the first image; and
a guide image generation unit which generates, based on a position of the partial area of the contents, a guide image in which the first image is arranged on the second image and a third image representing a position and a size of the partial area is arranged on the first image,
wherein the generated guide image is displayed on the screen.

7. The content display device according to claim 6,
further comprising:
a screen scroll unit which executes scrolling for the contents in accordance with an input operation by a user; and
an image moving unit which moves the third image in the first image in response to an operating amount of the scrolling or moving the first image in the second image while moving the third image in the first image in response to the operating amount of the scrolling,
wherein, when the first image is moved by the image moving means, the first image is updated by an image including an image of the partial area to which the content has been scrolled.

8. The content display device according to claim 6, wherein the guide image is displayed on the screen only while the scrolling is executed.

9. The content display device according to claim 6,
wherein the image generation unit calculates a height and a width of the second image based a result of the calculation and a displaying size of the first image, and when the calculated height and the width of the second image exceed a predetermined height and a predetermined width, the image generation unit reduces the calculated height and width to the predetermined height and the predetermined width.

10. A computer-readable medium having computer-readable instructions stored thereon, which, when executed by a processor, analyze contents created especially for a display area wider than a screen size and displays a partial area of the contents, the instructions configure the processor to function as:
a first image generation unit which generates, based on a result of the analysis, a first image generated by reducing an image of a predetermined range including at least the partial area of the contents which is being displayed or to be displayed on the screen;
a second image generation unit which generates a second image representing an entire area of the contents based on a result of the analysis and a displaying size of the first image;
a guide image generation unit which generates, based on a position of the partial area of the contents, a guide image in which the first image is arranged on the second image and a third image representing a position and a size of the partial area is arranged on the first image; and
a guide image display unit which displays the generated guide image at a position not obstructing browsing of the contents on the screen.

11. A computer-readable medium having computer-readable instructions stored thereon, which, when executed by a processor of a computer, analyze contents created especially for a display area wider than a screen size and displaying a partial area of the contents based on a result of analysis, the instructions configure the processor to perform:
a first image generation step of generating, based on a result of the analysis, a first image generated by reducing an image of a predetermined range including at least the partial area of the contents which is being displayed or to be displayed on the screen;
a step of calculating a height and a width of the contents;
a second image generation step of generating a second image representing the height and the width of the contents based on a result of the calculation and a displaying size of the first image;
a guide image generation step of generating, based on a position of the partial area of the contents, a guide image in which the first image is arranged on the second image and a third image representing a position and a size of the partial area is arranged on the first image; and
a guide image displaying step of displaying the generated guide image on the screen.
